(19) United States
(12) Patent Application Publication
(10) Pub. No.: US 2025/0088854 A1
(43) Pub. Date: Mar. 13, 2025

(54) FRAME PROTECTION IN WIRELESS COMMUNICATIONS

(71) Applicant: QUALCOMM Incorporated, San Diego, CA (US)

(72) Inventors: Abhishek Pramod PATIL, San Diego, CA (US); Sai Yiu Duncan HO, San Diego, CA (US); Abdel Karim AJAMI, San Diego, CA (US); Alfred ASTERJADHI, San Diego, CA (US); Gaurang NAIK, San Diego, CA (US); Yanjun SUN, San Diego, CA (US); George CHERIAN, San Diego, CA (US)

(21) Appl. No.: 18/465,962

(22) Filed: Sep. 12, 2023

(51) Int. Cl. H04W 12/106; H04W 12/037; H04W 56/00

(52) U.S. Cl. CPC H04W 12/106; H04W 12/037; H04W 56/001; H04W 84/12

(57) ABSTRACT

This disclosure provides methods, components, devices and systems for frame protection in wireless communications. Some aspects more specifically relate to a first wireless device (such as a STA or AP) that may transmit frames with a packet number (PN) that has a time-based portion and a counter value. In some examples, the time-based portion may include a truncated timing synchronization function (TSF) value that indicates a time at which the frame was transmitted from the first wireless device, and the counter value may be incremented for each frame that is transmitted with a same truncated TSF value. A second wireless device may receive the frame and compare the truncated TSF with a current local time based on a truncated local TSF. The second wireless device may process the frame or discard the frame based on the comparison.

### TECHNICAL FIELD

This disclosure relates to wireless communication and, more specifically, to frame protection in wireless communications.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a data frame sent over-the-air between a STA or AP wirelessly communicating with another STA or AP includes information, such as a source address, a destination address, a duration/ID field, or a high throughput (HT) control field, in a media access control (MAC) header of the data frame. Some fields in the MAC header, such as the duration/ID field or HT control field, may be unprotected as such fields may not be encrypted or subject to an integrity check. A rogue device may exploit such unprotected fields, which may result in a receiving device taking actions that may be undesirable.

### SUMMARY

The systems, methods, and devices of this disclosure each have several innovative aspects, no single one of which is solely responsible for the desirable attributes disclosed herein.

A first wireless communication device for wireless communications is described. The first wireless communication device may include a processing system that includes processor circuitry and memory circuitry that stores code. The processing system may be configured to cause the first wireless communication device to generate a packet number for a frame to be transmitted to a second wireless communication device, the packet number including a first subset of bits that corresponds to a portion of a timing synchronization function value associated with the frame and a second subset of bits that corresponds to a counter value and transmit the frame to the second wireless communication device, the frame including a portion that includes the packet number.

A second wireless communication device for wireless communications is described. The second wireless communication device may include a processing system that includes processor circuitry and memory circuitry that stores code. The processing system may be configured to cause the second wireless communication device to receive a frame that includes a packet number including a first subset of bits that correspond to a first timing synchronization function value associated with the frame and a second subset of bits that correspond to a counter value and process the frame based at least on part on whether a time value indicated by the first subset of bits corresponds to a local time maintained at the second wireless communication device.

Another first wireless communication device for wireless communications is described. The first wireless communication device may include a processing system that includes processor circuitry and memory circuitry that stores code. The processing system may be configured to cause the first wireless communication device to generate a message integrity check (MIC) field for a frame to be transmitted to a second wireless communication device, perform an exclusive-OR (XOR) function on the MIC field to generate an XORed MIC field in which bits of the MIC field are XORed with a set of bits that correspond to a portion of a timing synchronization function value associated with the frame, and transmit the frame, including the XORed MIC field, to the second wireless communication device.

Another second wireless communication device for wireless communications is described. The second wireless communication device may include a processing system that includes processor circuitry and memory circuitry that stores code. The processing system may be configured to cause the second wireless communication device to receive a frame that includes a message integrity check (MIC) field, perform an exclusive-OR (XOR) function on the MIC field to generate an XORed MIC field in which bits of the MIC field are XORed with a set of bits that correspond to a portion of a timing synchronization function value associated with a receipt time of the frame, and process the XORed MIC field to determine frame integrity of the frame.

A method for wireless communications by a first wireless communication device is described. The method may include generating a packet number for a frame to be transmitted to a second wireless communication device, the packet number including a first subset of bits that corresponds to a portion of a timing synchronization function value associated with the frame and a second subset of bits that corresponds to a counter value and transmitting the frame to the second wireless communication device, the frame including a portion that includes the packet number.

In some examples of the method and first wireless communication device, the generating the packet number may include operations or instructions for generating the portion of the timing synchronization function value as a truncated version of the timing synchronization function value and appending the counter value to the portion of timing synchronization function value.

A method for wireless communications by a second wireless communication device is described. The method may include receiving a frame that includes a packet number including a first subset of bits that correspond to a first timing synchronization function value associated with the frame and a second subset of bits that correspond to a counter value and processing the frame based at least on part on whether a time value indicated by the first subset of bits corresponds to a local time maintained at the second wireless communication device.

Some examples of the methods and second wireless communication devices described herein may further include operations or instructions for generating a second timing synchronization function value as a truncated version of a time value of a timing synchronization function at the second wireless communication device, where the local time maintained at the second wireless communication device corresponds to the second timing synchronization function value, and where the frame may be processed based on the second timing synchronization function value matching the first timing synchronization function value.

Another method for wireless communications by a first wireless communication device is described. The method may include generating a message integrity check (MIC) field for a frame to be transmitted to a second wireless communication device, performing an exclusive-OR (XOR) function on the MIC field to generate an XORed MIC field in which bits of the MIC field are XORed with a set of bits that correspond to a portion of a timing synchronization function value associated with the frame, and transmitting the frame, including the XORed MIC field, to the second wireless communication device.

In some examples of the method and first wireless communication device, the portion of the timing synchronization function value may be a truncated version of the timing synchronization function value at the first wireless communication device.

Another method for wireless communications by a second wireless communication device is described. The method may include receiving a frame that includes a message integrity check (MIC) field, performing an exclusive-OR (XOR) function on the MIC field to generate an XORed MIC field in which bits of the MIC field are XORed with a set of bits that correspond to a portion of a timing synchronization function value associated with a receipt time of the frame, and processing the XORed MIC field to determine frame integrity of the frame.

In some examples of the method and second wireless communication device, the portion of the timing synchronization function value may be a truncated version of the timing synchronization function value at the second wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a time-based packet number that supports frame protection in wireless communications.

FIG. 6 shows an example of a signaling diagram that supports frame protection in wireless communications.

FIG. 7 shows an example of a process flow that supports frame protection in wireless communications.

FIG. 8 shows an example of a process flow that supports frame protection in wireless communications.

FIG. 9 shows a block diagram of an example wireless communication device that supports frame protection in wireless communications.

FIG. 10 shows a block diagram of an example wireless communication device that supports frame protection in wireless communications.

FIG. 11 shows a flowchart illustrating an example process performable by or at a first wireless communication device that supports frame protection in wireless communications.

FIG. 12 shows a flowchart illustrating an example process performable by or at a second wireless communication device that supports frame protection in wireless communications.

FIG. 13 shows a flowchart illustrating an example process performable by or at a first wireless communication device that supports frame protection in wireless communications.

FIG. 14 shows a flowchart illustrating an example process performable by or at a second wireless communication device that supports frame protection in wireless communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

A WLAN may include one or more access points (APs) and non-AP stations (STAs) that communicate with each other via specific communication links (such as channels within a given frequency band). In some WLANs that support multi-link operations (MLO), a non-AP STA may be affiliated with a non-AP multi-link device (MLD) that operates on multiple communication links. Likewise, an AP may be affiliated with (for example, controlled or managed by) one or more AP MLDs that operate on more than one communication link. As used herein, the term “STA” may refer to any type of wireless STA, such as a non-AP STA, a non-MLD STA, a non-MLD non-AP STA, or the like. Similarly, the term “AP” may refer to any type of wireless AP, such as an AP MLD or a non-MLD AP, among other examples.

Security in WLAN communications may be provided through mechanisms that protect certain control frames and fields within medium access control (MAC) header, such as encryption, integrity checks, or both. Even with such security mechanisms, in some implementations, there may be attack scenarios in which a rogue device may be able to jam the reception of a frame, while recording the frame. Later, the attacker may replay the unmodified frame, which may prompt the receiver to take actions that might be undesirable (for example, the receiver may consider the transmitter to be in a different operational state than it is actually in because receipt of the original frame was not successful). Such attacks may be referred to as jam, record and replay attacks. In some implementations, protection against jam, record, and replay attacks may use a sequentially incremented packet number (PN) provided with a frame, where if a received PN is less than or equal to a prior received PN the receiver will drop the frame. However, in a jam, record, and replay attack, because the receiving device did not receive the original frame, it does not have a record of the PN carried in that frame, which could result in a successful attack in which the attacker is able to get around the replay detection logic.

Various aspects of the present disclosure relate generally to frame protection in wireless communications. Some aspects more specifically relate to protection against jam, record, and replay attacks through use of PNs that have a timing component. In some implementations, a first wireless device (such as an AP or a STA) may transmit a PN with each frame that has a time-based portion and a counter value. In some implementations, the time-based portion may include a truncated timing synchronization function (TSF) value that indicates a time at which the frame was transmitted from the first wireless device, and may thus provide a reduced granularity of time provided by the TSF. In some implementations, the counter value may be incremented for each frame that is transmitted with a same truncated TSF value. A second wireless device (such as an AP or a STA) may receive the frame and perform a replay check by comparing the received truncated TSF value with a current local truncated TSF value. If the received TSF value is lower than the truncated local TSF value, the frame may be dropped. If the received value is the same as the TSF value received in a previous frame, the received counter value is compared to the prior counter value and, if the received counter value is equal or less than previously received counter, the frame is dropped. Otherwise, the packet is processed further. Separate TSFs may be maintained at a wireless device for each link when operating in a multi-link configuration.

Additionally, or alternatively, some implementations provide protection for frames that may not have an unencrypted PN field (for example, certain management or data frames may encrypt the PN field). In some implementations, such frame protection may be provided using a message integrity check (MIC) transmitted with the frame. The MIC may be exclusive-ORed (XORed) with the truncated TSF value of the transmitting device. The receiving device may XOR the received MIC with the local truncated TSF value to obtain an XORed MIC. The receiving device may decrypt the received frame and derive a value of the MIC, and compare the XORed MIC with the derived MIC value. If there is a mismatch, the frame may be dropped, and otherwise further processing may be performed.

Particular aspects of the subject matter described in this disclosure can be implemented to realize one or more of the following potential advantages. In some implementations, using a time component as a portion of the PN, or as an XOR value in the XOR operation, may enable a receiving device to discard frames that have a delayed receipt at the receiving device, thus helping to prevent a jam, record, and replay attack and enhancing security and reliability in communications. Further, the reduced granularity of time values used in comparing the received time value and local time value allows for some clock drift between the transmitter and receiver. Additionally, the counter value provided with the time value may allow for multiple frames to be communicated with a same reduced granularity time value thus enhancing throughput and network efficiency.

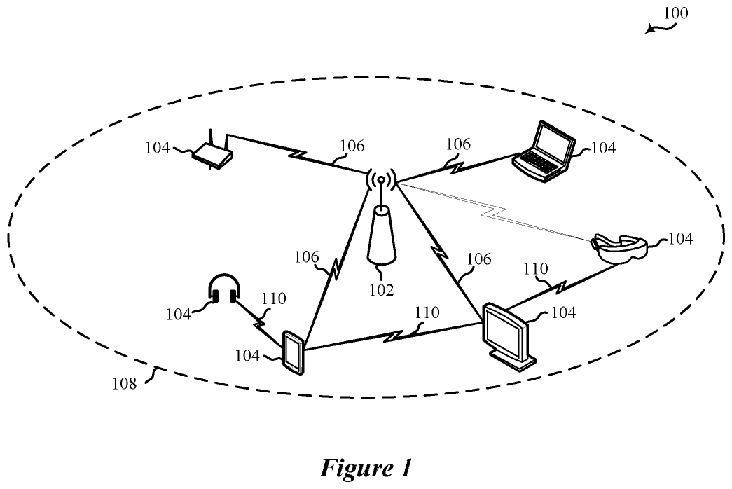

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some implementations, a first wireless device (such as a STA 104 or AP 102) may transmit frames via one or more communication links 106, and a PN provided with each frame may have a time-based portion and a counter value. In some implementations, the time-based portion may include a truncated TSF value that indicates a time at which the frame was transmitted from the first wireless device. In some implementations, the counter value may be incremented for each frame that is transmitted with a same truncated TSF value and be appended to the truncated TSF value. A second wireless device (such as a STA 104 or AP 102) may receive the frame and perform a replay check by comparing the truncated TSF with a current local time based on a truncated local TSF. The second wireless device may process the frame or discard the frame based on the replay check. Additionally, or alternatively, the first wireless device may use a MIC for frame protection, where the MIC may be XORed with the truncated TSF value of the first wireless device. The second wireless device may XOR the received MIC with the local truncated TSF value to obtain an XORed MIC. The receiving device may decrypt the received frame and derive a value of the MIC, and compare the XORed MIC with the derived MIC value. If there is a mismatch, the frame is dropped, and otherwise further processing may be performed.

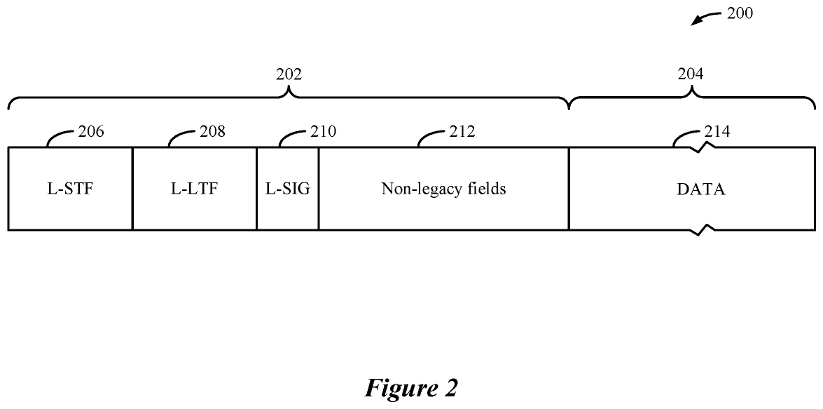

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, a first wireless device (such as a STA or AP) may transmit a PN with each frame that may have a time-based portion and a counter value. In some implementations, the time-based portion may include a truncated TSF value that indicates a time at which the frame was transmitted from the first wireless device. In some implementations, the counter value may be incremented for each frame that is transmitted with a same truncated TSF value and be appended to the truncated TSF value. A second wireless device (such as a STA or AP) may receive the frame and perform a replay check by comparing the truncated TSF with a current local time based on a truncated local TSF. The second wireless device may process the frame or discard the frame based on the replay check. Additionally, or alternatively, the first wireless device may use a MIC for frame protection, where the MIC may be XORed with the truncated TSF value of the first wireless device. The second wireless device may XOR the received MIC with the local truncated TSF value to obtain an XORed MIC. The receiving device may decrypt the received frame and derive a value of the MIC, and compare the XORed MIC with the derived MIC value. If there is a mismatch, the frame is dropped, and otherwise further processing may be performed.

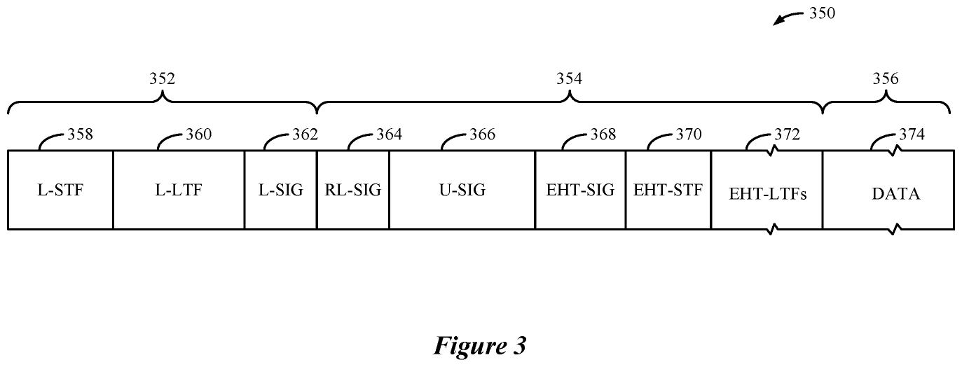

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some implementations, a first wireless device (such as a STA or AP) may transmit a PN with each frame that may have a time-based portion and a counter value. In some implementations, the time-based portion may include a truncated TSF value that indicates a time at which the frame was transmitted from the first wireless device. In some implementations, the counter value may be incremented for each frame that is transmitted with a same truncated TSF value and be appended to the truncated TSF value. A second wireless device (such as a STA or AP) may receive the frame and perform a replay check by comparing the truncated TSF with a current local time based on a truncated local TSF. The second wireless device may process the frame or discard the frame based on the replay check. Additionally, or alternatively, the first wireless device may use a MIC for frame protection, where the MIC may be XORed with the truncated TSF value of the first wireless device. The second wireless device may XOR the received MIC with the local truncated TSF value to obtain an XORed MIC. The receiving device may decrypt the received frame and derive a value of the MIC, and compare the XORed MIC with the derived MIC value. If there is a mismatch, the frame is dropped, and otherwise further processing may be performed.

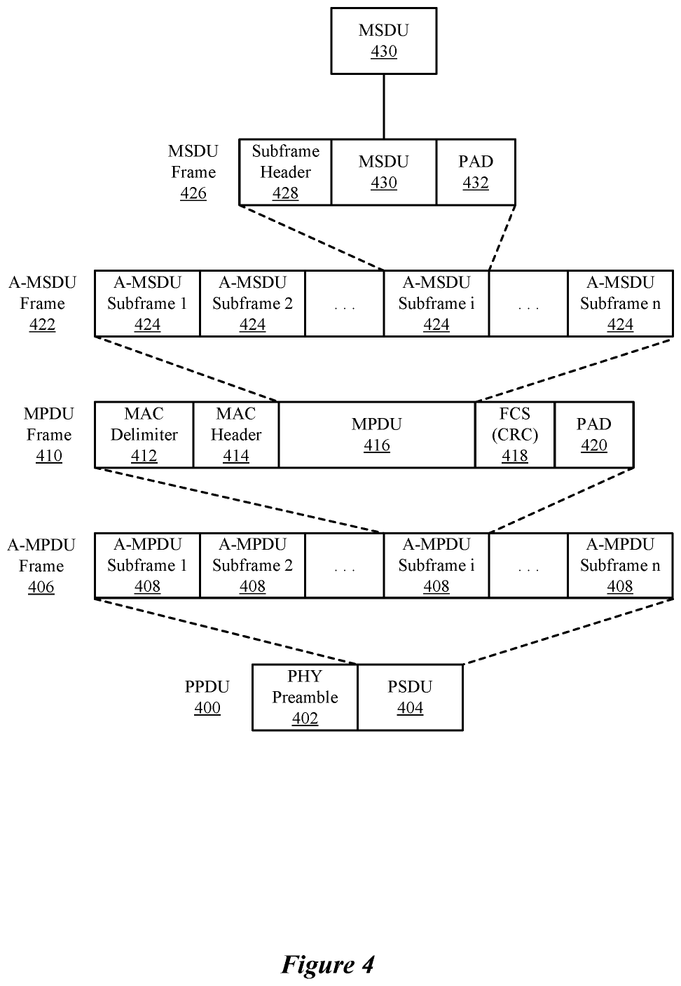

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU frame 426 with a MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Some wireless communication devices (including both APs and STAs such as, for example, AP 102 and STAs 104 described with reference to FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHz, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some implementations, a first wireless device (such as a STA or AP) may transmit a PN with each frame that may have a time-based portion and a counter value. In some implementations, the time-based portion may include a truncated TSF value that indicates a time at which the frame was transmitted from the first wireless device. In some implementations, the counter value may be incremented for each frame that is transmitted with a same truncated TSF value and be appended to the truncated TSF value. A second wireless device (such as a STA or AP) may receive the frame and perform a replay check by comparing the truncated TSF with a current local time based on a truncated local TSF. In some implementations, MLO techniques may be used, and a separate TSF may be maintained, or TSFs may be synchronized, for each link or two or more links at the first wireless device or the second wireless device. The second wireless device may process the frame or discard the frame based on the replay check. Additionally, or alternatively, the first wireless device may use a MIC for frame protection, where the MIC may be XORed with the truncated TSF value of the first wireless device. The second wireless device may XOR the received MIC with the local truncated TSF value to obtain an XORed MIC. The receiving device may decrypt the received frame and derive a value of the MIC, and compare the XORed MIC with the derived MIC value. If there is a mismatch, the frame is dropped, and otherwise further processing may be performed.

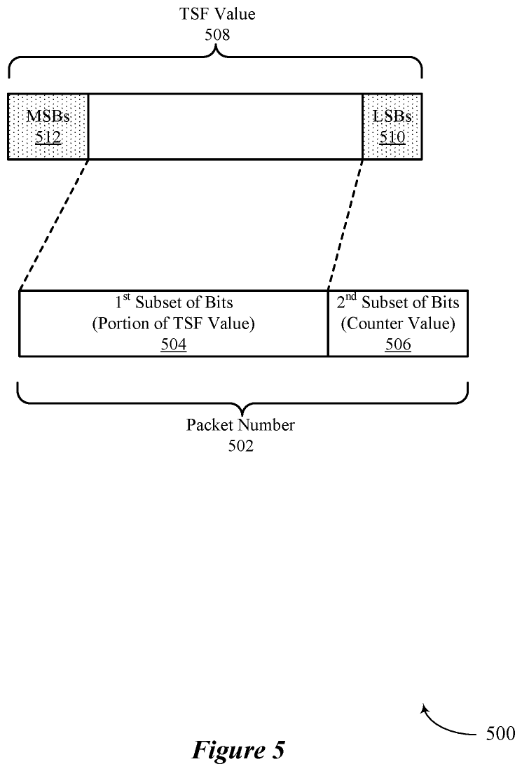

FIG. 5 shows an example of a time-based packet number 500 that supports frame protection in wireless communications. The time-based packet number 500 may implement one or more aspects of the wireless communication network 100. For example, the time-based packet number 500 may be provided with frames transmitted by an AP 102 or a STA 104, as shown and described with reference to FIG. 1.

In some implementations, protection against jam, record, and replay attacks may be provided through use of a PN 502 that includes a first subset of bits 504 and a second subset of bits 506. The first subset of bits 504 maybe time-related bits that are obtained from a TSF value 508. For example, the first subset of bits may be obtained by truncating the TSF value 508 to remove a quantity of least significant bits (LSBs) 510. Further, in some implementations, one or more most significant bits (MSBs) 512 may be removed from the TSF value 508. The second subset of bits 506 may correspond to a counter value that is incremented for each frame that is transmitted with a same first subset of bits 504.

In some implementations, a first wireless device (such as an AP or a STA) may transmit PN 502 with each frame. A second wireless device (such as an AP or a STA) may receive the frame and perform a replay check by comparing the truncated TSF value provided in the first subset of bits 504 with a current local time based on a truncated local TSF. If the received truncated TSF value provided in the first subset of bits 504 is lower than the truncated local TSF value, the frame may be dropped. If the received value is the same as a received TSF value received in a previous frame, the received counter value provided in the second subset of bits 506 is compared to a prior counter value of the previous frame and, if the received counter value is equal or less than the prior counter value, the frame is dropped. Otherwise, the frame is processed further.

In some implementations, the truncated TSF value that indicates a time at which the frame was transmitted from the first wireless device, and may thus provide a reduced granularity of time provided by the full TSF value 508. In some implementations a number of truncated bits (for example, a quantity of bits of the LSBs 510) may be a specified value, or negotiated between the first wireless device and the second wireless device based on their capability. The counter value of the second subset of bits 506 may be appended to the truncated TSF value of the first subset of bits 504, and may increment each time a frame is transmitted with the same truncated TSF value, and reset to zero when a LSB of the truncated TSF rolls over.

In some implementations, the PN 502 may be used to protect a frame and to aid replay check, where a frame is considered as replayed by the receiving device if the received PN 502 has a first subset of bits 504 with a lower value than the corresponding value generated at the receiving device based on its local TSF. In some implementations, the PN 502 may be included in plaintext within the frame so that the receiving device knows the PN that was used for protection (for example, MIC generation or encryption of the payload). As discussed herein, in jam, record, and replay attacks, a rogue device may attempt to get around replay detection logic by jamming the original frame and later replaying the unmodified frame. Techniques as discussed herein that use a truncated TSF value as the first subset of bits 504 may further protect against such attacks by linking the PN 502 to a transmission time, and thus the delayed are replayed frame would be discarded because the received PN 502 of the frame includes a truncated TSF value that is less than the truncated TSF value at the receiving device.

In accordance with implementations discussed herein, the truncated TSF may allow for clock draft between the transmitting device and the receiving device. For example, a receiving device may be allowed to have extend periods of an inactive or doze state to conserve battery. In one specific example, a receiving device may have indicated a listen interval (LI) of 10, and may thus be allowed to skip up to 10 beacons. In cases where a target beacon transmission time (TBTT) is every 100 ms, the receiving device with LI of 10 will skip beacons for one second. Further, because clocks at the transmitting and receiving devices run independently on each device, clock drift may occur over time. For example, clocks at the different devices may have an accuracy of +/−100 ppm, in accordance with some standards. Therefore, in a worst-case drift between the transmitting device and the receiving device may be +/−200 ppm. Thus, a receiving device in such an example may have its local TSF off by 200 μs with respect to the transmitting device after skipping 10 beacons (1 sec). In implementations where the TSF has a granularity of microseconds (μs), this would result in a mismatch in TSF values if the LSBs 510 of the TSF value 508 were compared at the receiving device. Thus, by truncating the LSBs 510 from the TSF value 508, the granularity of the indicated time value is reduced and may hide the clock drift. In some implementations, the number of LSBs 510 to mask may be specified and used by all devices in a network. In other implementations, the number of LSBs 510 to mask may be negotiated between the two devices based on one or more of their capability, a LI used at the receiving device, an expected clock drift at the devices, a traffic flow, or any combinations thereof. For example, the TSF value 508 may be truncated by 8 bits of a 64 bit TSF value 508, which may reduce the timing granularity to 1/4 of a time unit (TU), or 256 μs, which may be sufficient to address most the clock drift scenarios.

However, the reduced granularity in time may result in multiple packets sent within a reduced granularity time window (for example, within a 256 μs window) that have a same value of the truncated TSF provided in the first subset of bits 504. The counter value provided in the second subset of bits 506 may be used to differentiate different frames that are transmitted with a same truncated TSF value.

In other implementations, protection against replay attacks may be provided by having a receiving device synchronize its TSF with the transmitting device TSF after transitioning to an awake state. Such synchronization may allow an untruncated TSF value 508 to be used as a PN. Further, in cases where a serving AP's clock is slower, the PN in AP's downlink frame will have a lower TSF, and to avoid such scenarios a client may not indicate wake state to the AP until it has synchronized its TSF. In further implementations, transmitting and receiving devices may specify or negotiate a window of time for acceptable PN (TSF) values. For example, a fixed size window of TSF values may be provided by a standard, or the two devices can negotiate a window based on their capabilities (for example, LI and expected clock drift), and a receiving device may accept packets that have a TSF value that lies within the window.

Referring again to the example of FIG. 5, the counter value provided in the second subset of bits 506 may be used to differentiate different frames that are transmitted with a same truncated TSF value. In some implementations, the value of the counter may be incremented each time a frame is transmitted with the same TSF value, and the counter value may reset to zero when the LSB of the truncated TSF provided in the first subset of bits 504 rolls over. Thus, in such implementations, the overall PN 502 is a concatenation of the partial TSF and an X-bit counter (for example, where X=8). In some implementations, the PN 502 may include 48 bits, and the second subset of bits 506 may correspond to the lower octet and may represent a counter. Thus, the PN 502 may include PN[0:7] that corresponds to an 8-bit counter, and PN[8:47] that corresponds to truncated TSF value with bits TSF [8:47]. In some implementations, the TSF value 508 may be a 64-bit value, and in this example bits TSF[48:63], corresponding to MSBs 512, are not signaled.

In some implementations, at the receiving device, the replay check is performed by comparing the partial TSF with current local time from the local TSF function. If the received value is lower than the partial local TSF, the frame may be dropped. In cases where the received partial TSF is the same as the TSF received in a prior frame, the receiving device may compare the received counter value to the counter value of the prior frame. If the received counter value is equal or less than the prior frame counter, the frame may be dropped. Otherwise, in case where the frame is not dropped, further frame processing is performed. For a frame that passes the replay check and subsequent checks (for example, MIC validation), the receiving device may record the received partial TSF and the counter value as the last know values, respectively, for use in a subsequent replay check. In some implementations, due to clock drift, there is a corner case when the 9th bit of the TSF (when 8 bits are truncated) may have recently flipped at the receiving device but this bit has not flipped at the transmitting device. For example, the receiving devices bits of TSFR[0:8]=100000001; while transmitter is TSFT[0:8]=011111101, corresponding to a 4 μs time difference. In such cases, some tolerance may be implemented to allow for such TSF value differences. In some implementations, such tolerance may be predefined or negotiated between the two devices.

In some implementations, when a value of the PN 502 wraps around, both devices may perform a rekeying operation to generate a new security key for encrypted communications. In some implementations, TSF [8:47], such a wraparound would occur after 2\hat{ }48 μs, or approximately 3258 days. In other implementations, seamless roaming and MLO techniques may be used, and one or more PN 502 MIBs may be set aside for signaling an identified of the PN space. In such implementations, if 8 MSBs are used for PN space ID, then TSF [8:39] are available for the partial TSF, corresponding to 2\hat{ }40 μs or about 13 days. Such time frames for rekeying operations provide, for most scenarios, that TSF/PN wraparound will not be the reason for rekeying.

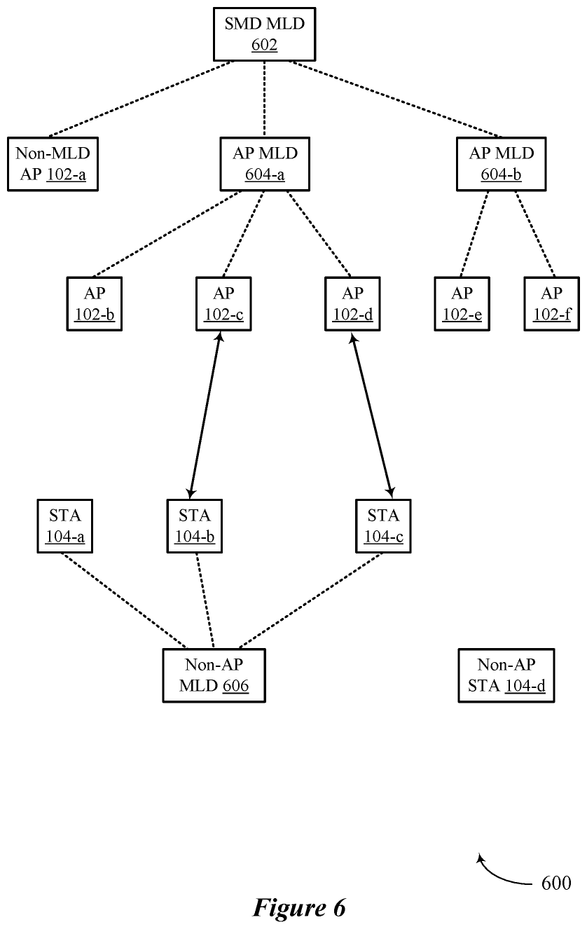

FIG. 6 shows an example of a signaling diagram 600 that supports frame protection in wireless communications. The signaling diagram 600 may implement one or more aspects of the wireless communication network 100. For example, the signaling diagram 600 includes an AP 102-a (such as a non-MLD AP), and AP 102-b (such as an MLD AP), an AP 102-c, an AP 102-d, an AP 102-e, and an AP 102-f, which may be examples of aspects of an AP 102, as shown and described with reference to FIG. 1. Likewise, the signaling diagram 600 includes a STA 104-a (such as a non-AP MLD STA), a STA 104-b, a STA 104-c, and a STA 104-d (such as a non-MLD non-AP STA), which may be examples of a STA 104, as shown and described with reference to FIG. 1.

As used herein, the term “AP” encompasses both non-MLD APs (for example, APs that operate on a single communication link) and MLD APs 604 that operate on more than one communication link. Likewise, the term “STA” encompasses both non-MLD non-AP STAs (such as STAs that operate on a single communication link) and non-AP MLD STA that operate on more than one communication link. Thus, in the following description of the signaling diagram 600, when referring to communications between a STA and an AP, the “STA” may be a non-MLD non-AP STA (for example, a non-AP STA that is not affiliated with a non-AP MLD, such as the STA 104-d) or an non-AP MLD STA (such as the STA 104-c affiliated with the non-AP MLD 606), and the “AP” may be a non-MLD AP (such as the AP 102-a) or an MLD AP (such as the AP 102-d affiliated with the AP MLD 604-a or the AP 102-e affiliated with the AP MLD 604-b). In some implementations, a serving AP (or a centralized controller) may provide security key(s) associated with a particular client/STA to neighboring APs that are affiliated with the same single mobility domain (SMD) MLD 602.

In accordance with the described techniques, in MLO, each affiliated AP, such as the AP 102-b, the AP 102-c, and the AP 102-d, is allowed to have an independent clock. As a result, the TSF value on each link can be a different value. In some implementations, a PN that is based on partial TSF may be a per-link PN. In other implementations, affiliated Aps, such as the AP 102-b, the AP 102-c, and the AP 102-d, may have a same clock, and thus the TSF values may be the same across each associated link. In such implementations, the TSF-based PN may be elevated to MLD level, such as the AP MLD 604-a level. In such implementations, the second subset of bits on the PN that provide the counter value may account for frame transmissions across all of the corresponding links (for example across links for each of the AP 102-b, the AP 102-c, and the AP 102-d). In some implementations, a number of bits of the second subset of bits of the PN may be selected to account for the counter value incrementing for each frame across multiple links. Additionally, or alternatively, a total length of the PN may be increased to allocate more bits for the counter, or to use the extra bits for signaling link ID information for seamless roaming.

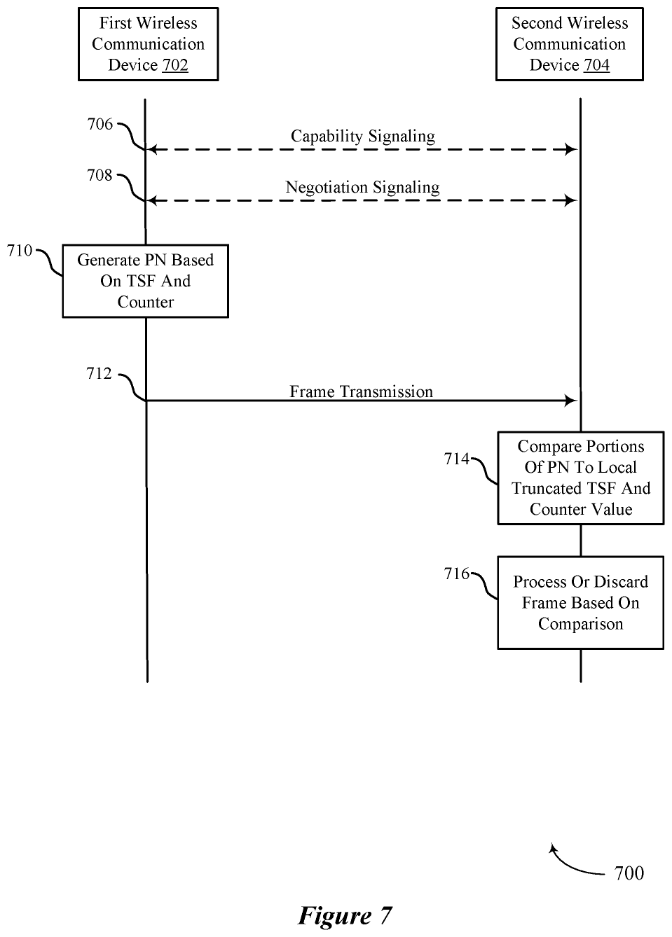

FIG. 7 shows an example of a process flow 700 that supports frame protection in wireless communications. The process flow 700 may implement one or more aspects of the wireless communication network 100 or the signaling diagram 600, as shown and described with reference to FIGS. 1 and 6. For example, the process flow 700 includes a first wireless device 702 (such as an AP or a STA), and a second wireless device 704 (such as an AP or a STA).

At 706, optionally, the first wireless device 702 and the second wireless device 704 may exchange capability signaling. The capability signaling may indicate, for example, capability to perform time-based PN operations, expected clock drift, MLO capabilities, or any combinations thereof.

At 708, optionally, the first wireless device 702 and the second wireless device 704 may exchange negotiation signaling. The negotiation signaling may include, for example, a requested number of bits of a TSF value that are to be truncated, which may be based on expected clock drift at one or both of the first wireless device 702 and the second wireless device 704. Additionally, or alternatively, this negotiation can be for one or more specific traffic flows. For example, there may be one or more traffic flows for which one or both of the first wireless device 702 and the second wireless device 704 may not care about having a time-based replay check, and certain other flows which that are more critical from security point of view that are to be protected based on time-based PN. In such implementations, time-based PN replay checks may be enabled or disabled per traffic flow based on the negotiation, and/or a number of truncated bits of the TSF value may be negotiated per traffic flow. Additionally, or alternatively, the TSF truncation value that is negotiated may be based on a listen interval (LI) for the non-AP device. Further, in some implementations, an AP may or may not have different truncation values for different non-APs depending on their capability. For example, for a legacy non-AP STA, the AP may not use time based PN, while for a later generation non-AP, the negotiated value may depend on one or more of support for the feature (that is, whether the device supports the feature), the clock drift, listen interval, traffic flow, and the like.

At 710, the first wireless communication device 702 may generate a PN based on its TSF value and a counter. As discussed herein, the PN may include a first subset of bits that include a truncated TSF value, and a second subset of bits that include a counter value. The counter value may be incremented for each transmitted frame that has a same truncated TSF value in the first subset of bits. At 712, the first wireless device 702 may transmit, and the second wireless device 704 may receive, a frame transmission that includes the PN.

At 714, the second wireless device 704 may compare portions of the PN to a local truncated TSF and counter value. As discussed herein, the second wireless device 704 may maintain an independent TSF that provides a local TSF value. The second wireless device 704 may obtain the local TSF value, truncate the local TSF value in accordance with the number of bits that are to be truncated, and compare the two TSF values. Further, in the event that the two TSF values are the same, the second wireless device 704 may compare the counter value provided in the second subset of bits.

At 716, the second wireless device 704 may process or discard the frame based on the comparison. For example, if the received truncated TSF value is less than the local truncated TSF value, the second wireless device 704 may discard the frame.

Further, if the received truncated TSF value is the same as the local truncated TSF value, the second wireless device 704 may determine whether a prior received frame has the same truncated TSF value. If the prior received frame does not have the same truncated TSF value, the second wireless device 704 may proceed with further processing of the frame. In the event that the prior received frame does have the same truncated TSF value, the second wireless device 704 may compare the counter value of the second subset of bits to a prior counter value of the prior frame. If the counter value of the received frame is higher than the prior counter value of the prior frame, further processing of the received frame may be performed, and otherwise the frame may be dropped.

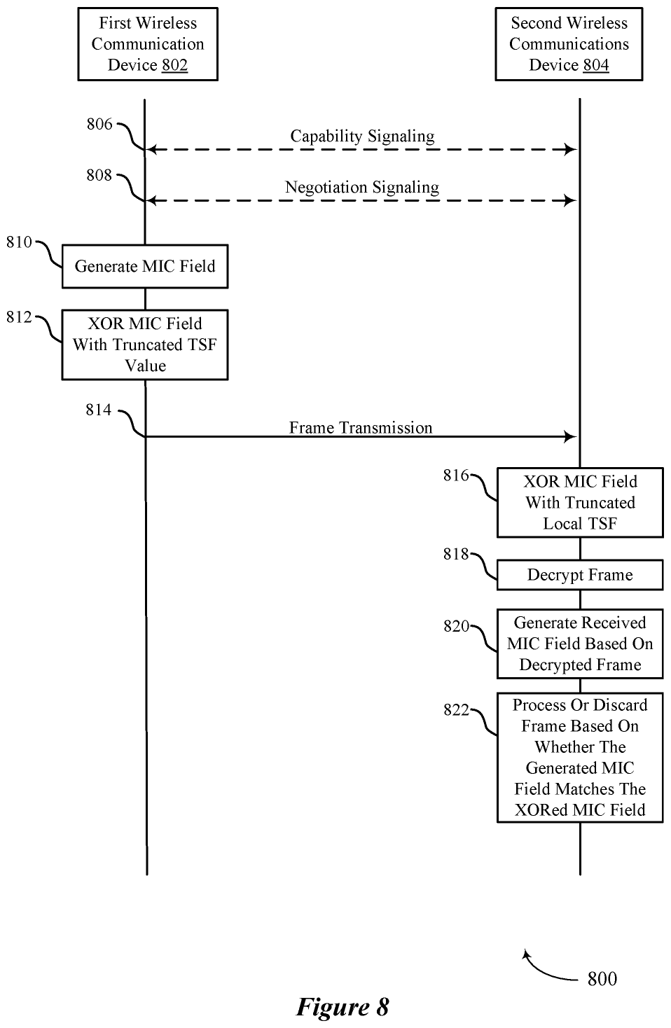

FIG. 8 shows an example of a process flow 800 that supports frame protection in wireless communications. The process flow 800 may implement one or more aspects of the wireless communication network 100 or the signaling diagram 600, as shown and described with reference to FIGS. 1 and 6. For example, the process flow 800 includes a first wireless device 802 (such as an AP or a STA), and a second wireless device 804 (such as an AP or a STA).

At 806, optionally, the first wireless device 802 and the second wireless device 804 may exchange capability signaling. The capability signaling may indicate, for example, capability to perform time-based PN operations, perform XOR MIC checks for data or management frames, expected clock drift, MLO capabilities, or any combinations thereof.

At 808, optionally, the first wireless device 802 and the second wireless device 804 may exchange negotiation signaling. The negotiation signaling may include, for example, a requested number of bits of a TSF value that are to be truncated for use in an XOR operation on a MIC, which may be based on expected clock drift at one or both of the first wireless device 802 and the second wireless device 804. Additionally, or alternatively, this negotiation can be for one or more specific traffic flows. For example, there may be one or more traffic flows for which one or both of the first wireless device 802 and the second wireless device 804 may not care about having a time-based replay check, and certain other flows which that are more critical from security point of view that are to be protected based on time-based PN. In such implementations, time-based PN replay checks may be enabled or disabled per traffic flow based on the negotiation, and/or a number of truncated bits of the TSF value may be negotiated per traffic flow. Additionally, or alternatively, the TSF truncation value that is negotiated may be based on a LI for the non-AP device. Further, in some implementations, an AP may or may not have different truncation values for different non-APs depending on their capability. For example, for a legacy non-AP STA, the AP may not use time based PN, while for a later generation non-AP, the negotiated value may depend on one or more of support for the feature (that is, whether the device supports the feature), the clock drift, listen interval, traffic flow, and the like.

At 810, the first wireless communication device 802 may generate MIC field. The MIC field may be generated in accordance with established techniques based on a subset of MAC header fields, and is generated during encryption of an MPDU's payload. Because the contents of the header fields can change when an MPDU is retried, a fresh MIC is generated only for the header fields each time an MPDU is retried, and the payload of the MPDU is not re-encrypted. In some implementations, control frames also may be protected via a MIC.

At 812, the first wireless device 802 may perform an XOR operation to XOR the MIC field with a truncated TSF value provided by a TSF at the first wireless device 802. As discussed herein, the truncated TSF may have one or more LSBs that are truncated to accommodate clock draft between the first wireless device 802 and the second wireless device 804. In some implementations, a number of bits in the truncated TSF corresponds to a number of bits in the MIC, and the XOR operation is performed on each bit of the MIC and the truncated TSF. In other implementations, the truncated TSF and MIC may have a different number of bits, and padding may be used for the value with fewer bits. At 814, the first wireless device 802 may transmit, and the second wireless device 804 may receive, a frame transmission that includes XORed MIC field. In some implementations, the frame may be a data or management frame.

At 816, the second wireless device 804 may perform an XOR operation to XOR the received MIC field with a truncated version of a local TSF value, to obtain the transmitted MIC field. At 818, the second wireless device 804 may decrypt the received frame in accordance with an encryption procedure established for communications between the first wireless device 802 and the second wireless device 804. At 818, the second wireless device 804 may generate a received MIC field based on the decrypted frame.

At 822, the second wireless device 804 may process or discard the received frame based on whether the generated MIC field matches the XORed received MIC field. In some implementations, the second wireless device 804 may process the received frame if the two MICs match, and may drop the received frame if there is a mismatch between the two MICs. In some implementations, the XORed MIC value may be different when the packet is retransmitted since the TSF would have changed at the first wireless device 802, and this the replay check and XOR operation provides the MIC associated with the transmitted frame for the MIC check that may be performed if the frame is not discarded. In some implementations, the retransmitted frame may occur on any link in MLD operations, and the TSF corresponding to that link will be used during the XOR step at the first wireless device 802 and at the second wireless device 804.

In some other implementations, a TSF-based PN may be used for encryption of a management or date frame to help prevent replay attacks. In such implementations, the payload of the frame may be re-encrypted for retransmissions of the frame. Further, such techniques may provide that associated APs have a common clock and a synchronized TSF.

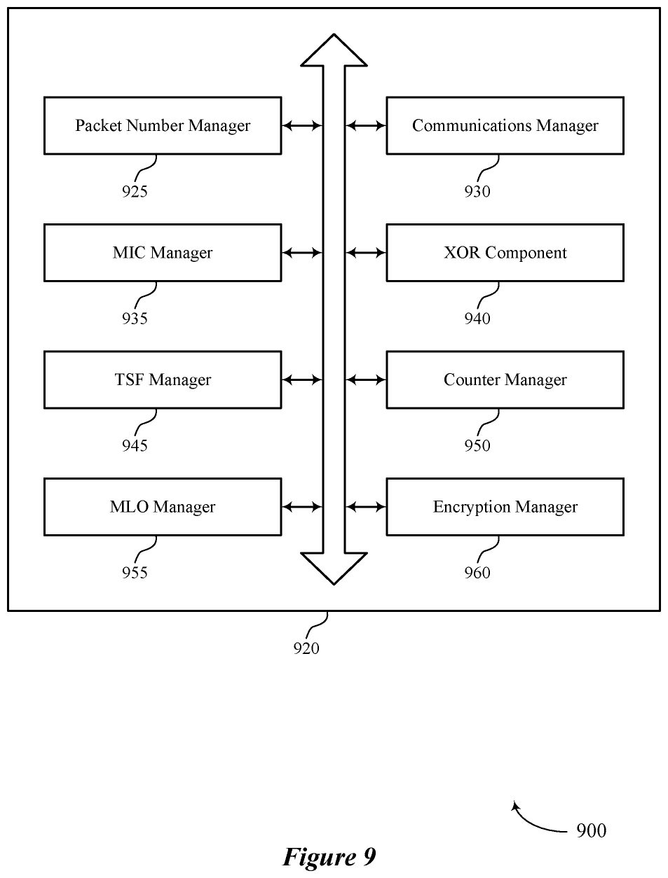

FIG. 9 shows a block diagram 900 of a first wireless device 920 that supports frame protection in wireless communications in accordance with one or more aspects of the present disclosure. The first wireless device 920 may be an example of aspects of a first wireless device as described with reference to FIGS. 2-8. The first wireless device 920, or various components thereof, may be an example of means for performing various aspects of frame protection in wireless communications as described herein. For example, the first wireless device 920 may include a packet number manager 925, a communications manager 930, a MIC manager 935, a XOR component 940, an TSF manager 945, a counter manager 950, an MLO manager 955, an encryption manager 960, or any combination thereof. Each of these components, or components or subcomponents thereof (e.g., one or more processors, one or more memories), may communicate, directly or indirectly, with one another (e.g., via one or more buses).

The wireless communication device 920 may support wireless communications in accordance with examples as disclosed herein. The packet number manager 925 is configurable or configured to generate a packet number for a frame to be transmitted to a second wireless communication device, the packet number including a first subset of bits that corresponds to a portion of a timing synchronization function value associated with the frame and a second subset of bits that corresponds to a counter value. The communications manager 930 is configurable or configured to transmit the frame to the second wireless communication device, the frame including a portion that includes the packet number. In some examples, the frame include a header portion and the packet number is used to protect contents of the header portion. In some examples, the frame be a control frame and the packet number is used to protect contents of the control frame.

In some examples, to support generating the packet number, the TSF manager 945 is configurable or configured to generate the portion of the timing synchronization function value as a truncated version of the timing synchronization function value. In some examples, to support generating the packet number, the counter manager 950 is configurable or configured to append the counter value to the portion of timing synchronization function value. In some examples, the truncated version of the timing synchronization function value may be truncated through removal of a quantity of least significant bits of the timing synchronization function value.

In some examples, the TSF manager 945 is configurable or configured to communicate with the second wireless communication device to negotiate a number of bits to be truncated from the timing synchronization function value. In some examples, the number of bits to be truncated are different for different traffic flows, the number of bits to be truncated are based on a listen interval of the first wireless communication device or the second wireless communication device, or any combinations thereof. In some examples, the truncated version of the timing synchronization function value may be truncated by an amount that is based on potential clock drift between the first wireless communication device and the second wireless communication device.

In some examples, the first wireless communication device may be a non multi-link device (MLD) non-access point (AP) STA or a non-AP STA that is affiliated with a non-AP MLD and the second wireless communication device is a non-MLD AP or an AP that is affiliated with an AP MLD, or the first wireless communication device is a non-MLD AP or an AP that is affiliated with an AP MLD and the second wireless communication device is a non-AP MLD non-AP STA or a non-AP STA that is affiliated with a non-AP MLD. In some examples, the non-AP STA may synchronize its timing synchronization function with a corresponding timing synchronization function at the associated AP, that is operating on that link, upon a transition of the non-AP STA to an awake state.

In some examples, the portion of the timing synchronization function value may correspond to a time window of acceptable timing synchronization function values that is a specified time window or has a duration that is negotiated with the second wireless communication device.

In some examples, the frame may be a first frame that has a first portion of the timing synchronization function value and a first counter value, and a second frame that is transmitted subsequent to the first frame has the first portion of the timing synchronization function value and a second counter value that is an incremented value from the first counter value. In some examples, a subsequent counter value for a subsequent frame to the second frame be reset to zero responsive to a change of the portion of the timing synchronization function value.

In some examples, the TSF manager 945 is configurable or configured to communicate with the second wireless communication device to negotiate a tolerance between the timing synchronization function value and a corresponding timing synchronization function value at the second wireless communication device that allows for processing of the frame at the second wireless communication device.

In some examples, the encryption manager 960 is configurable or configured to rekey an encryption key associated with communications between the first wireless communication device and the second wireless communication device responsive to the packet number resetting to an initial value. In some examples, the first wireless communication device may be a MLD that operates on multiple links, and where separate timing synchronization functions are maintained at each link. In some examples, the first wireless communication device may be a MLD that operates on multiple links, and where a same timing synchronization function is used to generate timing synchronization function values for each link.

Additionally, or alternatively, the wireless communication device 900 may support wireless communications in accordance with examples as disclosed herein. The MIC manager 935 is configurable or configured to generate a message integrity check (MIC) field for a frame to be transmitted to a second wireless communication device. The XOR component 940 is configurable or configured to perform an exclusive-OR (XOR) function on the MIC field to generate an XORed MIC field in which bits of the MIC field are XORed with a set of bits that correspond to a portion of a timing synchronization function value associated with the frame. In some examples, the communications manager 930 is configurable or configured to transmit the frame, including the XORed MIC field, to the second wireless communication device.

In some examples, the MIC field may be generated during encryption of the frame. In some examples, the portion of the timing synchronization function value may be a truncated version of the timing synchronization function value at the first wireless communication device. In some examples, the truncated version of the timing synchronization function value may be truncated through removal of a quantity of least significant bits of the timing synchronization function value.

In some examples, the truncated version of the timing synchronization function value may be truncated by an amount that is based on potential clock drift between the first wireless communication device and at least the second wireless communication device. In some examples, the truncated version of the timing synchronization function value may be truncated through removal of a quantity of least significant bits of the timing synchronization function value.

In some examples, the communications manager 930 is configurable or configured to retransmit data included in the frame in a subsequent frame, where the subsequent frame includes an updated XORed MIC field based on a corresponding subsequent timing synchronization function value associated with the subsequent frame. In some examples, contents of the subsequent frame be not re-encrypted when the frame is retransmitted. In some examples, the frame may be a data frame or a management frame.

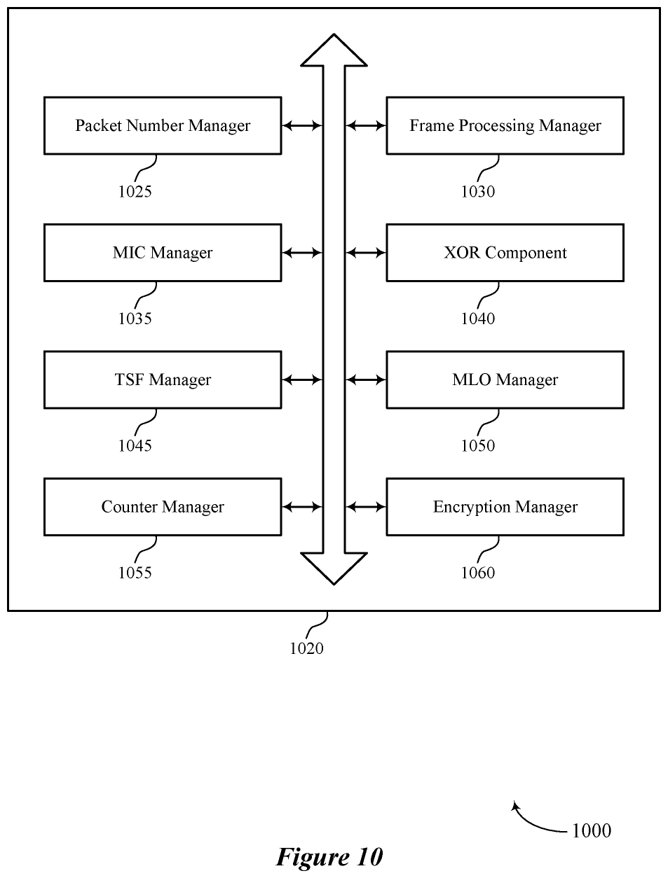

FIG. 10 shows a block diagram 1000 of a second wireless device 1020 that supports frame protection in wireless communications in accordance with one or more aspects of the present disclosure. The second wireless device 1020 may be an example of aspects of a second wireless device as described with reference to FIGS. 2-8. The second wireless device 1020, or various components thereof, may be an example of means for performing various aspects of frame protection in wireless communications as described herein. For example, the second wireless device 1020 may include a packet number manager 1025, a frame processing manager 1030, a MIC manager 1035, a XOR component 1040, an TSF manager 1045, an MLO manager 1050, a counter manager 1055, an encryption manager 1060, or any combination thereof. Each of these components, or components or subcomponents thereof (e.g., one or more processors, one or more memories), may communicate, directly or indirectly, with one another (e.g., via one or more buses).

The wireless communication device 1020 may support wireless communications in accordance with examples as disclosed herein. The packet number manager 1025 is configurable or configured to receive a frame that includes a packet number including a first subset of bits that correspond to a first timing synchronization function value associated with the frame and a second subset of bits that correspond to a counter value. The frame processing manager 1030 is configurable or configured to process the frame based at least on part on whether a time value indicated by the first subset of bits corresponds to a local time maintained at the second wireless communication device.

In some examples, the frame may include a header portion and the packet number is used to protect contents of the header portion. In some examples, the frame may be a control frame and the packet number is used to protect contents of the control frame.

In some examples, the TSF manager 1045 is configurable or configured to generate a second timing synchronization function value as a truncated version of a time value of a timing synchronization function at the second wireless communication device, where the local time maintained at the second wireless communication device corresponds to the second timing synchronization function value, and where the frame is processed based on the second timing synchronization function value matching the first timing synchronization function value.

In some examples, the TSF manager 1045 is configurable or configured to communicate with a first wireless communication device to negotiate a number of bits to be truncated from the time value of the timing synchronization function, and where the frame is transmitted by the first wireless communication device. In some examples, the number of bits to be truncated are different for different traffic flows, the number of bits to be truncated are based on a listen interval of the first wireless communication device or the second wireless communication device, or any combinations thereof.

In some examples, the truncated version of the time value of the timing synchronization function allows for clock drift between the second wireless communication device and at least a first wireless communication device.

In some examples, the second wireless communication device may be a non multi-link device (MLD) AP, or an AP that is affiliated with an AP MLD, and communicates with a first wireless communication device is a non-MLD non-AP STA or a non-AP STA that is affiliated with a non-AP MLD, or the first wireless communication device is a non-MLD AP or an AP that is affiliated with an AP MLD and the second wireless communication device is a non-AP MLD non-AP STA or a non-AP STA that is affiliated with a non-AP MLD. In some examples, the non-AP STA synchronize its timing synchronization function with a corresponding timing synchronization function at the associated AP, that is operating on that link, upon a transition of the non-AP STA to an awake state.

In some examples, the first timing synchronization function value may correspond to a time window of acceptable timing synchronization function values that is a specified time window or has a duration that is negotiated with a first wireless communication device. In some examples, the frame may be a first frame that has a first timing synchronization function value and a first counter value, and a second frame that is transmitted subsequent to the first frame has the first timing synchronization function value and a second counter value that is an incremented value from the first counter value. In some examples, a subsequent counter value for a subsequent frame to the second frame may be reset to zero responsive to a change of the first timing synchronization function value.

In some examples, the TSF manager 1045 is configurable or configured to compare the first subset of bits to a third subset of bits that correspond to a second timing synchronization function value generated at the second wireless communication device and associated with a time at which the frame is received.

In some examples, the frame processing manager 1030 is configurable or configured to discard the frame responsive to a mismatch between the first subset of bits and the third subset of bits. In some examples, the frame processing manager 1030 is configurable or configured to determine, responsive to a match between the first subset of bits and the third subset of bits, that the frame is an initial frame received with the first timing synchronization function value or that the counter value exceeds a prior counter value of a prior frame with the first timing synchronization function value. In some examples, the frame processing manager 1030 is configurable or configured to process the frame. In some examples, the frame processing manager 1030 is configurable or configured to discard the frame responsive to the frame the counter value being equal to or less than a previously received counter value with the first timing synchronization function value.

In some examples, the TSF manager 1045 is configurable or configured to record the first timing synchronization function value and the counter value for use in processing a subsequent frame header. In some examples, the TSF manager 1045 is configurable or configured to communicate with a first wireless communication device to negotiate a tolerance between the first timing synchronization function value and a corresponding timing synchronization function value at the first wireless communication device that allows for processing of the frame at the second wireless communication device.

In some examples, the encryption manager 1060 is configurable or configured to rekey an encryption key associated with communications between the second wireless communication device and a first wireless communication device responsive to the packet number resetting to an initial value. In some examples, the second wireless device be a multi-link device (MLD) that operates on multiple links, and where separate timing synchronization functions are maintained at each link.

Additionally, or alternatively, the wireless communication device 1000 may support wireless communications in accordance with examples as disclosed herein. The MIC manager 1035 is configurable or configured to receive a frame that includes a message integrity check (MIC) field. The XOR component 1040 is configurable or configured to perform an exclusive-OR (XOR) function on the MIC field to generate an XORed MIC field in which bits of the MIC field are XORed with a set of bits that correspond to a portion of a timing synchronization function value associated with a receipt time of the frame. In some examples, the frame processing manager 1030 is configurable or configured to process the XORed MIC field to determine frame integrity of the frame.

In some examples, the TSF manager 1045 is configurable or configured to the portion of the timing synchronization function value be a truncated version of the timing synchronization function value at the second wireless communication device. In some examples, the truncated version of the timing synchronization function value may be truncated by an amount that is based on potential clock drift between the second wireless communication device and a first wireless communication device.

In some examples, the encryption manager 1060 is configurable or configured to decrypt the frame. In some examples, the MIC manager 1035 is configurable or configured to generate a received frame MIC field based on the decrypted frame. In some examples, the frame processing manager 1030 is configurable or configured to discard the frame responsive to a mismatch between the received frame MIC field and the XORed MIC field, or decode the frame responsive to a match between the received frame MIC field and the XORed MIC field. In some examples, the second wireless communication device may be a MLD that operates on multiple links, and where separate timing synchronization functions are maintained at each link.

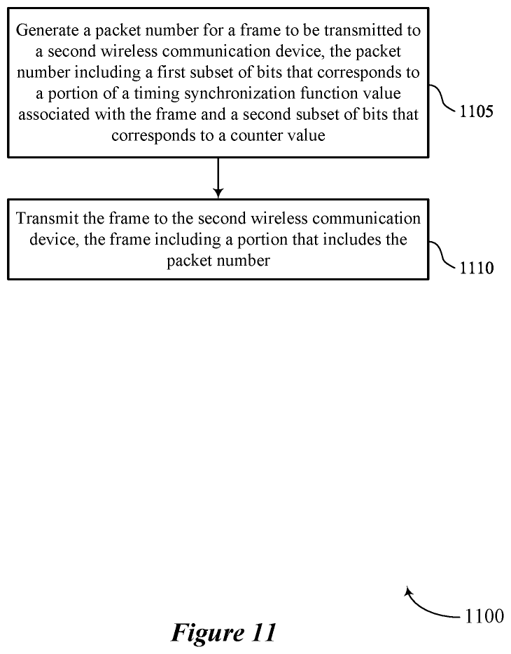

FIG. 11 shows a flowchart illustrating a method 1100 that supports frame protection in wireless communications in accordance with one or more aspects of the present disclosure. The operations of the method 1100 may be implemented by a first wireless device or its components as described herein. For example, the operations of the method 1100 may be performed by a first wireless device as described with reference to FIGS. 2-9. In some examples, a first wireless device may execute a set of instructions to control the functional elements of the first wireless device to perform the described functions. Additionally, or alternatively, the first wireless device may perform aspects of the described functions using special-purpose hardware.

At 1105, the method may include generating a packet number for a frame to be transmitted to a second wireless communication device, the packet number including a first subset of bits that corresponds to a portion of a timing synchronization function value associated with the frame and a second subset of bits that corresponds to a counter value. The operations of block 1105 may be performed in accordance with examples as disclosed herein, such as the generation of a PN 502 of FIG. 5, and/or the generation of a PN at 710 of FIG. 7. The PN may include information similar to that described with respect to, and illustrated in, FIGS. 5-7. In some examples, aspects of the operations of 1105 may be performed by a packet number manager 925 as described with reference to FIG. 9.

At 1110, the method may include transmitting the frame to the second wireless communication device, the frame including a portion that includes the packet number. The operations of block 1110 may be performed in accordance with examples as disclosed herein, such as the transmission of a frame 410 of FIG. 4, and/or the transmission of a frame at 712 of FIG. 7. The frame may include information similar to that described with respect to, and illustrated in, FIGS. 5-7. In some examples, aspects of the operations of 1110 may be performed by a communications manager 930 as described with reference to FIG. 9.

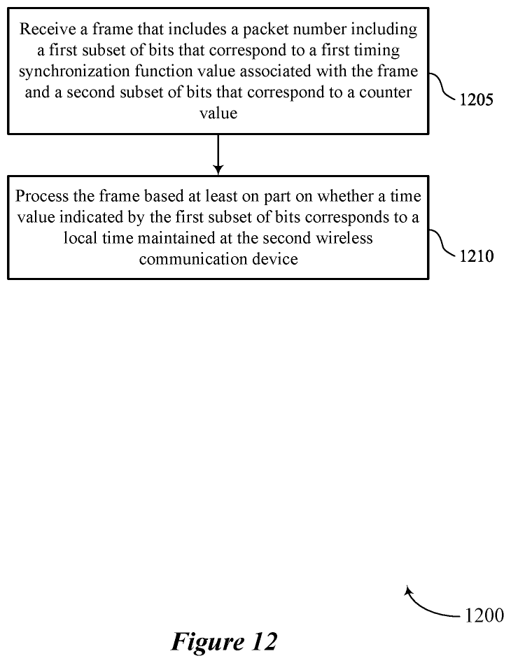

FIG. 12 shows a flowchart illustrating a method 1200 that supports frame protection in wireless communications in accordance with one or more aspects of the present disclosure. The operations of the method 1200 may be implemented by a second wireless device or its components as described herein. For example, the operations of the method 1200 may be performed by a second wireless device as described with reference to FIGS. 2-8 and 10. In some examples, a second wireless device may execute a set of instructions to control the functional elements of the second wireless device to perform the described functions. Additionally, or alternatively, the second wireless device may perform aspects of the described functions using special-purpose hardware.

At 1205, the method may include receiving a frame that includes a packet number including a first subset of bits that correspond to a first timing synchronization function value associated with the frame and a second subset of bits that correspond to a counter value. The operations of block 1205 may be performed in accordance with examples as disclosed herein, such as the reception of a frame 410 of FIG. 4, and/or the reception of a frame at 712 of FIG. 7. The frame may include information similar to that described with respect to, and illustrated in, FIGS. 5-7. In some examples, aspects of the operations of 1205 may be performed by a packet number manager 1025 as described with reference to FIG. 10.

At 1210, the method may include processing the frame based at least on part on whether a time value indicated by the first subset of bits corresponds to a local time maintained at the second wireless communication device. The operations of block 1210 may be performed in accordance with examples as disclosed herein, such as the processing of a frame 410 of FIG. 4, and/or the processing of a frame at 714 and 716 of FIG. 7. The frame may include information similar to that described with respect to, and illustrated in, FIGS. 5-7. In some examples, aspects of the operations of 1210 may be performed by a frame processing manager 1030 as described with reference to FIG. 10.

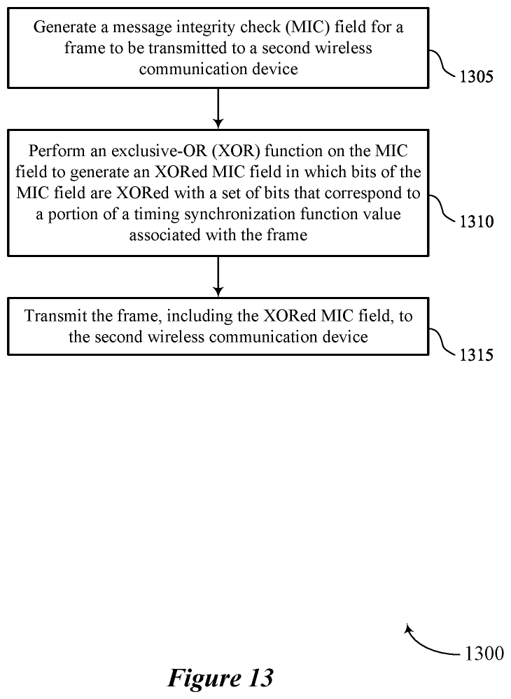

FIG. 13 shows a flowchart illustrating a method 1300 that supports frame protection in wireless communications in accordance with one or more aspects of the present disclosure. The operations of the method 1300 may be implemented by a first wireless device or its components as described herein. For example, the operations of the method 1300 may be performed by a first wireless device as described with reference to FIGS. 2-9. In some examples, a first wireless device may execute a set of instructions to control the functional elements of the first wireless device to perform the described functions. Additionally, or alternatively, the first wireless device may perform aspects of the described functions using special-purpose hardware.

At 1305, the method may include generating a message integrity check (MIC) field for a frame to be transmitted to a second wireless communication device.

The operations of block 1305 may be performed in accordance with examples as disclosed herein, such as MIC generation at 810 of FIG. 8. The MIC may include information similar to that described with respect to, and illustrated in, FIGS. 5-8. In some examples, aspects of the operations of 1305 may be performed by a MIC manager 935 as described with reference to FIG. 9.

At 1310, the method may include performing an exclusive-OR (XOR) function on the MIC field to generate an XORed MIC field in which bits of the MIC field are XORed with a set of bits that correspond to a portion of a timing synchronization function value associated with the frame. The operations of block 1310 may be performed in accordance with examples as disclosed herein, such as XOR of the MIC field at 812 of FIG. 8. The MIC may include information and be processed in an XOR operation similar to that described with respect to, and illustrated in, FIGS. 5-8. In some examples, aspects of the operations of 1310 may be performed by a XOR component 940 as described with reference to FIG. 9.

At 1315, the method may include transmitting the frame, including the XORed MIC field, to the second wireless communication device. The operations of block 1315 may be performed in accordance with examples as disclosed herein, such as the transmission of a frame 410 of FIG. 4, and/or the transmission of a frame at 814 of FIG. 8. The frame may include information similar to that described with respect to, and illustrated in, FIGS. 5-8. In some examples, aspects of the operations of 1315 may be performed by a communications manager 930 as described with reference to FIG. 9.

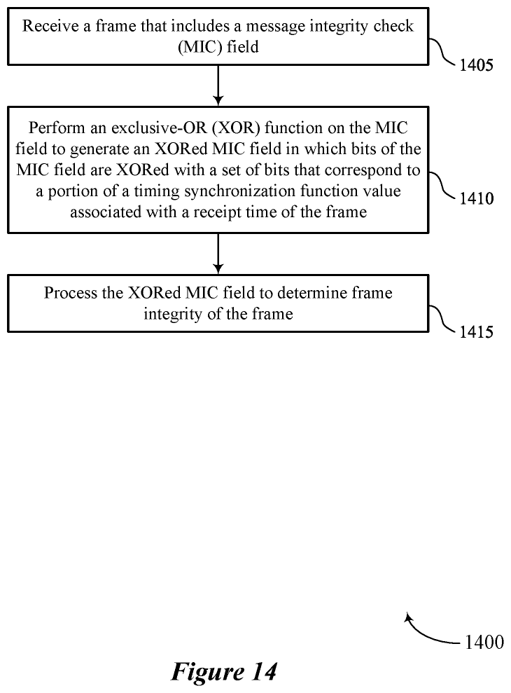

FIG. 14 shows a flowchart illustrating a method 1400 that supports frame protection in wireless communications in accordance with one or more aspects of the present disclosure. The operations of the method 1400 may be implemented by a second wireless device or its components as described herein. For example, the operations of the method 1400 may be performed by a second wireless device as described with reference to FIGS. 2-8 and 10. In some examples, a second wireless device may execute a set of instructions to control the functional elements of the second wireless device to perform the described functions. Additionally, or alternatively, the second wireless device may perform aspects of the described functions using special-purpose hardware.

At 1405, the method may include receiving a frame that includes a message integrity check (MIC) field. The operations of block 1405 may be performed in accordance with examples as disclosed herein, such as the reception of a frame 410 of FIG. 4, and/or the reception of a frame at 814 of FIG. 8. The frame may include information similar to that described with respect to, and illustrated in, FIGS. 5-8. In some examples, aspects of the operations of 1405 may be performed by a MIC manager 1035 as described with reference to FIG. 10.

At 1410, the method may include performing an exclusive-OR (XOR) function on the MIC field to generate an XORed MIC field in which bits of the MIC field are XORed with a set of bits that correspond to a portion of a timing synchronization function value associated with a receipt time of the frame. The operations of block 1410 may be performed in accordance with examples as disclosed herein, such as XOR of the MIC field at 816 of FIG. 8. The MIC may include information and be processed in an XOR operation similar to that described with respect to, and illustrated in, FIGS. 5-8. In some examples, aspects of the operations of 1410 may be performed by a XOR component 1040 as described with reference to FIG. 10.

At 1415, the method may include processing the XORed MIC field to determine frame integrity of the frame. The operations of block 1415 may be performed in accordance with examples as disclosed herein, such as the processing of a MIC field at 820 and 822 of FIG. 8. The MIC field may include information similar to that described with respect to, and illustrated in, FIGS. 5-8. In some examples, aspects of the operations of 1415 may be performed by a frame processing manager 1030 as described with reference to FIG. 10.

Implementation examples are described in the following numbered clauses:

Clause 1: A first wireless communication device, including: a processing system that includes processor circuitry and memory circuitry that stores code, the processing system configured to cause the first wireless device to: generate a packet number for a frame to be transmitted to a second wireless communication device, the packet number including a first subset of bits that corresponds to a portion of a timing synchronization function value associated with the frame and a second subset of bits that corresponds to a counter value; and transmit the frame to the second wireless communication device, the frame including a portion that includes the packet number.

Clause 2: The first wireless communication device of clause 1, wherein the frame includes a header portion and the packet number is used to protect contents of the header portion.

Clause 3: The first wireless communication device of any of clauses 1 through 2, wherein the frame is a control frame and the packet number is used to protect contents of the control frame.

Clause 4: The first wireless communication device of any of clauses 1 through 3, wherein the contents of the frame are protected via an integrity check that generates a MIC across content that it so be protected, or via encryption of the content that is to be protected.

Clause 5: The first wireless communication device of any of clauses 1 through 4, wherein to generate the packet number, the processing system is configured to cause the first wireless device to: generate the portion of the timing synchronization function value as a truncated version of the timing synchronization function value; and append the counter value to the portion of timing synchronization function value.

Clause 6: The first wireless communication device of clause 5, wherein the truncated version of the timing synchronization function value is truncated through removal of a quantity of least significant bits of the timing synchronization function value.

Clause 7: The first wireless communication device of any of clauses 5 through 6, wherein the processing system is configured to cause the first wireless device to: communicate with the second wireless communication device to negotiate a number of bits to be truncated from the timing synchronization function value.

Clause 8: The first wireless communication device of clause 7, wherein the number of bits to be truncated are different for different traffic flows, the number of bits to be truncated are based at least in part on a listen interval of the first wireless communication device or the second wireless communication device, or any combinations thereof.

Clause 9: The first wireless communication device of any of clauses 5 through 8, wherein the truncated version of the timing synchronization function value is truncated by an amount that is based at least in part on potential clock drift between the first wireless communication device and the second wireless communication device.

Clause 10: The first wireless communication device of any of clauses 1 through 9, wherein the first wireless communication device is a non MLD non-AP STA or a non-AP STA that is affiliated with a non-AP MLD and the second wireless communication device is a non-MLD AP or an AP that is affiliated with an AP MLD, or the first wireless communication device is a non-MLD AP or an AP that is affiliated with an AP MLD and the second wireless communication device is a non-AP MLD non-AP STA or a non-AP STA that is affiliated with a non-AP MLD, and the non-AP STA synchronizes its timing synchronization function with a corresponding timing synchronization function at the associated AP, that is operating on that link, upon a transition of the non-AP STA to an awake state.

Clause 11: The first wireless communication device of any of clauses 1 through 10, wherein the portion of the timing synchronization function value corresponds to a time window of acceptable timing synchronization function values that is a specified time window or has a duration that is negotiated with the second wireless communication device.

Clause 12: The first wireless communication device of any of clauses 1 through 11, wherein the frame is a first frame that has a first portion of the timing synchronization function value and a first counter value, and a second frame that is transmitted subsequent to the first frame has the first portion of the timing synchronization function value and a second counter value that is an incremented value from the first counter value.

Clause 13: The first wireless communication device of clause 12, wherein a subsequent counter value for a subsequent frame to the second frame is reset to zero responsive to a change of the portion of the timing synchronization function value.

Clause 14: The first wireless communication device of any of clauses 1 through 13, wherein the processing system is configured to cause the first wireless device to: communicate with the second wireless communication device to negotiate a tolerance between the timing synchronization function value and a corresponding timing synchronization function value at the second wireless communication device that allows for processing of the frame at the second wireless communication device.

Clause 15: The first wireless communication device of any of clauses 1 through 14, wherein the processing system is configured to cause the first wireless device to: rekey an encryption key associated with communications between the first wireless communication device and the second wireless communication device responsive to the packet number resetting to an initial value.

Clause 16: The first wireless communication device of any of clauses 1 through 15, wherein the first wireless communication device is an MLD that operates on multiple links, and wherein separate timing synchronization functions are maintained at each link.

Clause 17: The first wireless communication device of any of clauses 1 through 16, wherein the first wireless communication device is an MLD that operates on multiple links, and wherein a same timing synchronization function is used to generate timing synchronization function values for each link.

Clause 18: A second wireless communication device including: a processing system that includes processor circuitry and memory circuitry that stores code, the processing system configured to cause the second wireless device to: receive a frame that includes a packet number including a first subset of bits that correspond to a first timing synchronization function value associated with the frame and a second subset of bits that correspond to a counter value; and process the frame based at least on part on whether a time value indicated by the first subset of bits corresponds to a local time maintained at the second wireless communication device.

Clause 19: The second wireless communication device of clause 18, wherein the frame includes a header portion and the packet number is used to protect contents of the header portion.

Clause 20: The second wireless communication device of any of clauses 18 through 19, wherein the frame is a control frame and the packet number is used to protect contents of the control frame.

Clause 21: The second wireless communication device of any of clauses 18 through 20, further comprising: generating a second timing synchronization function value as a truncated version of a time value of a timing synchronization function at the second wireless communication device, wherein the local time maintained at the second wireless communication device corresponds to the second timing synchronization function value, and wherein the frame is processed based at least in part on the second timing synchronization function value matching the first timing synchronization function value.

Clause 22: The second wireless communication device of clause 21, wherein the processing system is configured to cause the second wireless device to: communicate with a first wireless communication device to negotiate a number of bits to be truncated from the time value of the timing synchronization function, and wherein the frame is transmitted by the first wireless communication device.

Clause 23: The second wireless communication device of clause 22, wherein the number of bits to be truncated are different for different traffic flows, the number of bits to be truncated are based at least in part on a listen interval of the first wireless communication device or the second wireless communication device, or any combinations thereof.

Clause 24: The second wireless communication device of any of clauses 21 through 23, wherein the truncated version of the time value of the timing synchronization function allows for clock drift between the second wireless communication device and at least a first wireless communication device.

Clause 25: The second wireless communication device of any of clauses 18 through 24, wherein the second wireless communication device is a non MLD AP, or an AP that is affiliated with an AP MLD, and communicates with a first wireless communication device is a non-MLD non-AP STA or a non-AP STA that is affiliated with a non-AP MLD, or the first wireless communication device is a non-MLD AP or an AP that is affiliated with an AP MLD and the second wireless communication device is a non-AP MLD non-AP STA or a non-AP STA that is affiliated with a non-AP MLD, and the non-AP STA synchronizes its timing synchronization function with a corresponding timing synchronization function at the associated AP, that is operating on that link, upon a transition of the non-AP STA to an awake state.

Clause 26: The second wireless communication device of any of clauses 18 through 25, wherein the first timing synchronization function value corresponds to a time window of acceptable timing synchronization function values that is a specified time window or has a duration that is negotiated with a first wireless communication device.

Clause 27: The second wireless communication device of any of clauses 18 through 26, wherein the frame is a first frame that has a first timing synchronization function value and a first counter value, and a second frame that is transmitted subsequent to the first frame has the first timing synchronization function value and a second counter value that is an incremented value from the first counter value.

Clause 28: The second wireless communication device of clause 27, wherein a subsequent counter value for a subsequent frame to the second frame is reset to zero responsive to a change of the first timing synchronization function value.

Clause 29: The second wireless communication device of any of clauses 18 through 28, wherein the processing system is configured to cause the second wireless device to: compare the first subset of bits to a third subset of bits that correspond to a second timing synchronization function value generated at the second wireless communication device and associated with a time at which the frame is received.

Clause 30: The second wireless communication device of clause 29, wherein the processing system is configured to cause the second wireless device to: discard the frame responsive to a mismatch between the first subset of bits and the third subset of bits.

Clause 31: The second wireless communication device of any of clauses 29 through 30, wherein the processing system is configured to cause the second wireless device to: determine, responsive to a match between the first subset of bits and the third subset of bits, that the frame is an initial frame received with the first timing synchronization function value or that the counter value exceeds a prior counter value of a prior frame with the first timing synchronization function value; and processing the frame.

Clause 32: The second wireless communication device of any of clauses 29 through 31, wherein the processing system is configured to cause the second wireless device to: discard the frame responsive to the frame the counter value being equal to or less than a previously received counter value with the first timing synchronization function value.

Clause 33: The second wireless communication device of any of clauses 18 through 32, wherein the processing system is configured to cause the second wireless device to: record the first timing synchronization function value and the counter value for use in processing a subsequent frame header.

Clause 34: The second wireless communication device of any of clauses 18 through 33, further comprising: communicate with a first wireless communication device to negotiate a tolerance between the first timing synchronization function value and a corresponding timing synchronization function value at the first wireless communication device that allows for processing of the frame at the second wireless communication device.

Clause 35: The second wireless communication device of any of clauses 18 through 34, wherein the processing system is configured to cause the second wireless device to: rekey an encryption key associated with communications between the second wireless communication device and a first wireless communication device responsive to the packet number resetting to an initial value.

Clause 36: The second wireless communication device of any of clauses 18 through 35, wherein the second wireless device is an MLD that operates on multiple links, and wherein separate timing synchronization functions are maintained at each link.

Clause 37: The second wireless communication device of any of clauses 18 through 36, wherein the first wireless communication device is a MLD that operates on multiple links, and wherein a same timing synchronization function is used to generate timing synchronization function values for each link.

Clause 38: A first wireless communication device including: a processing system that includes processor circuitry and memory circuitry that stores code, the processing system configured to cause the first wireless device to: generate a MIC field for a frame to be transmitted to a second wireless communication device; perform an XOR function on the MIC field to generate an XORed MIC field in which bits of the MIC field are XORed with a set of bits that correspond to a portion of a timing synchronization function value associated with the frame; and transmit the frame, including the XORed MIC field, to the second wireless communication device.

Clause 39: The first wireless communication device of clause 38, wherein the MIC field is generated during encryption of the frame.

Clause 40: The first wireless communication device of any of clauses 38 through 39, wherein the portion of the timing synchronization function value is a truncated version of the timing synchronization function value at the first wireless communication device.

Clause 41: The first wireless communication device of clause 40, wherein the truncated version of the timing synchronization function value is truncated through removal of a quantity of least significant bits of the timing synchronization function value.

Clause 42: The first wireless communication device of any of clauses 40 through 41, wherein the truncated version of the timing synchronization function value is truncated by an amount that is based at least in part on potential clock drift between the first wireless communication device and at least the second wireless communication device.

Clause 43: The first wireless communication device of any of clauses 40 through 42, wherein the truncated version of the timing synchronization function value is truncated through removal of a quantity of least significant bits of the timing synchronization function value.

Clause 44: The first wireless communication device of any of clauses 38 through 43, wherein the processing system is configured to cause the first wireless device to: retransmitting data included in the frame in a subsequent frame, wherein the subsequent frame includes an updated XORed MIC field based on a corresponding subsequent timing synchronization function value associated with the subsequent frame.

Clause 45: The first wireless communication device of clause 44, wherein contents of the subsequent frame are not re-encrypted when the frame is retransmitted.

Clause 46: The first wireless communication device of any of clauses 38 through 45, wherein the frame is a data frame or a management frame.

Clause 47: A second wireless communication device including: a processing system that includes processor circuitry and memory circuitry that stores code, the processing system configured to cause the second wireless device to: receive a frame that includes a MIC field; perform an XOR function on the MIC field to generate an XORed MIC field in which bits of the MIC field are XORed with a set of bits that correspond to a portion of a timing synchronization function value associated with a receipt time of the frame; and process the XORed MIC field to determine frame integrity of the frame.

Clause 48: The second wireless communication device of clause 47, wherein the portion of the timing synchronization function value is a truncated version of the timing synchronization function value at the second wireless communication device.

Clause 49: The second wireless communication device of clause 48, wherein the truncated version of the timing synchronization function value is truncated by an amount that is based at least in part on potential clock drift between the second wireless communication device and a first wireless communication device.

Clause 50: The second wireless communication device of any of clauses 47 through 49, further comprising: decrypting the frame; generating a received frame MIC field based on the decrypted frame; and discarding the frame responsive to a mismatch between the received frame MIC field and the XORed MIC field, or decoding the frame responsive to a match between the received frame MIC field and the XORed MIC field.

Clause 51: The second wireless communication device of any of clauses 47 through 50, wherein the second wireless communication device is a MLD that operates on multiple links, and wherein separate timing synchronization functions are maintained at each link.

Clause 52: The second wireless communication device of any of clauses 47 through 51, wherein the first wireless communication device is a MLD that operates on multiple links, and wherein a same timing synchronization function is used to generate timing synchronization function values for each link.

Aspect 53: A method for wireless communications at a first wireless communication device, comprising: generating a packet number for a frame to be transmitted to a second wireless communication device, the packet number including a first subset of bits that corresponds to a portion of a timing synchronization function value associated with the frame and a second subset of bits that corresponds to a counter value; and transmitting the frame to the second wireless communication device, the frame including a portion that includes the packet number.

Aspect 54: The method of aspect 53, wherein the frame includes a header portion and the packet number is used to protect contents of the header portion.

Aspect 55: The method of any of aspects 53 through 54, wherein the frame is a control frame and the packet number is used to protect contents of the control frame.

Aspect 56: The method of any of aspects 53 through 55, wherein the contents of the frame are protected via an integrity check that generates a message integrity check (MIC) across content that it so be protected, or via encryption of the content that is to be protected.

Aspect 57: The method of any of aspects 53 through 56, wherein the generating the packet number comprises: generating the portion of the timing synchronization function value as a truncated version of the timing synchronization function value; and appending the counter value to the portion of timing synchronization function value.

Aspect 58: The method of aspect 57, wherein the truncated version of the timing synchronization function value is truncated through removal of a quantity of least significant bits of the timing synchronization function value.

Aspect 59: The method of any of aspects 57 through 58, further comprising: communicating with the second wireless communication device to negotiate a number of bits to be truncated from the timing synchronization function value.

Aspect 60: The method of aspect 59, wherein the number of bits to be truncated are different for different traffic flows, the number of bits to be truncated are based at least in part on a listen interval of the first wireless communication device or the second wireless communication device, or any combinations thereof.

Aspect 61: The method of any of aspects 57 through 60, wherein the truncated version of the timing synchronization function value is truncated by an amount that is based at least in part on potential clock drift between the first wireless communication device and the second wireless communication device.

Aspect 62: The method of any of aspects 53 through 61, wherein the first wireless communication device is a non multi-link device (MLD) non-access point (AP) STA or a non-AP STA that is affiliated with a non-AP MLD and the second wireless communication device is a non-MLD AP or an AP that is affiliated with an AP MLD, or the first wireless communication device is a non-MLD AP or an AP that is affiliated with an AP MLD and the second wireless communication device is a non-AP MLD non-AP STA or a non-AP STA that is affiliated with a non-AP MLD, and the non-AP STA synchronizes its timing synchronization function with a corresponding timing synchronization function at the associated AP, that is operating on that link, upon a transition of the non-AP STA to an awake state.

Aspect 63: The method of any of aspects 53 through 62, wherein the portion of the timing synchronization function value corresponds to a time window of acceptable timing synchronization function values that is a specified time window or has a duration that is negotiated with the second wireless communication device.

Aspect 64: The method of any of aspects 53 through 63, wherein the frame is a first frame that has a first portion of the timing synchronization function value and a first counter value, and a second frame that is transmitted subsequent to the first frame has the first portion of the timing synchronization function value and a second counter value that is an incremented value from the first counter value.

Aspect 65: The method of aspect 64, wherein a subsequent counter value for a subsequent frame to the second frame is reset to zero responsive to a change of the portion of the timing synchronization function value.

Aspect 66: The method of any of aspects 53 through 65, further comprising: communicating with the second wireless communication device to negotiate a tolerance between the timing synchronization function value and a corresponding timing synchronization function value at the second wireless communication device that allows for processing of the frame at the second wireless communication device.

Aspect 67: The method of any of aspects 53 through 66, further comprising: rekeying an encryption key associated with communications between the first wireless communication device and the second wireless communication device responsive to the packet number resetting to an initial value.

Aspect 68: The method of any of aspects 53 through 67, wherein the first wireless communication device is a multi-link device (MLD) that operates on multiple links, and wherein separate timing synchronization functions are maintained at each link.

Aspect 69: The method of any of aspects 53 through 68, wherein the first wireless communication device is a multi-link device (MLD) that operates on multiple links, and wherein a same timing synchronization function is used to generate timing synchronization function values for each link.

Aspect 70: A method for wireless communications at a second wireless communication device, comprising: receiving a frame that includes a packet number including a first subset of bits that correspond to a first timing synchronization function value associated with the frame and a second subset of bits that correspond to a counter value; and processing the frame based at least on part on whether a time value indicated by the first subset of bits corresponds to a local time maintained at the second wireless communication device.

Aspect 71: The method of aspect 70, wherein the frame includes a header portion and the packet number is used to protect contents of the header portion.

Aspect 72: The method of any of aspects 70 through 71, wherein the frame is a control frame and the packet number is used to protect contents of the control frame.

Aspect 73: The method of any of aspects 70 through 72, further comprising: generating a second timing synchronization function value as a truncated version of a time value of a timing synchronization function at the second wireless communication device, wherein the local time maintained at the second wireless communication device corresponds to the second timing synchronization function value, and wherein the frame is processed based at least in part on the second timing synchronization function value matching the first timing synchronization function value.

Aspect 74: The method of aspect 73, further comprising: communicating with a first wireless communication device to negotiate a number of bits to be truncated from the time value of the timing synchronization function, and wherein the frame is transmitted by the first wireless communication device.

Aspect 75: The method of aspect 74, wherein the number of bits to be truncated are different for different traffic flows, the number of bits to be truncated are based at least in part on a listen interval of the first wireless communication device or the second wireless communication device, or any combinations thereof.

Aspect 76: The method of any of aspects 73 through 75, wherein the truncated version of the time value of the timing synchronization function allows for clock drift between the second wireless communication device and at least a first wireless communication device.

Aspect 77: The method of any of aspects 70 through 76, wherein the second wireless communication device is a non multi-link device (MLD) AP, or an AP that is affiliated with an AP MLD, and communicates with a first wireless communication device is a non-MLD non-AP STA or a non-AP STA that is affiliated with a non-AP MLD, or the first wireless communication device is a non-MLD AP or an AP that is affiliated with an AP MLD and the second wireless communication device is a non-AP MLD non-AP STA or a non-AP STA that is affiliated with a non-AP MLD, and the non-AP STA synchronizes its timing synchronization function with a corresponding timing synchronization function at the associated AP, that is operating on that link, upon a transition of the non-AP STA to an awake state.

Aspect 78: The method of any of aspects 70 through 77, wherein the first timing synchronization function value corresponds to a time window of acceptable timing synchronization function values that is a specified time window or has a duration that is negotiated with a first wireless communication device.

Aspect 79: The method of any of aspects 70 through 78, wherein the frame is a first frame that has a first timing synchronization function value and a first counter value, and a second frame that is transmitted subsequent to the first frame has the first timing synchronization function value and a second counter value that is an incremented value from the first counter value.

Aspect 80: The method of aspect 79, wherein a subsequent counter value for a subsequent frame to the second frame is reset to zero responsive to a change of the first timing synchronization function value.

Aspect 81: The method of any of aspects 70 through 80, further comprising: comparing the first subset of bits to a third subset of bits that correspond to a second timing synchronization function value generated at the second wireless communication device and associated with a time at which the frame is received.

Aspect 82: The method of aspect 81, further comprising: discarding the frame responsive to a mismatch between the first subset of bits and the third subset of bits.

Aspect 83: The method of any of aspects 81 through 82, further comprising: determining, responsive to a match between the first subset of bits and the third subset of bits, that the frame is an initial frame received with the first timing synchronization function value or that the counter value exceeds a prior counter value of a prior frame with the first timing synchronization function value; and processing the frame.

Aspect 84: The method of any of aspects 81 through 83, further comprising: discarding the frame responsive to the frame the counter value being equal to or less than a previously received counter value with the first timing synchronization function value.

Aspect 85: The method of any of aspects 70 through 84, further comprising: recording the first timing synchronization function value and the counter value for use in processing a subsequent frame header.

Aspect 86: The method of any of aspects 70 through 85, further comprising: communicating with a first wireless communication device to negotiate a tolerance between the first timing synchronization function value and a corresponding timing synchronization function value at the first wireless communication device that allows for processing of the frame at the second wireless communication device.

Aspect 87: The method of any of aspects 70 through 86, further comprising: rekeying an encryption key associated with communications between the second wireless communication device and a first wireless communication device responsive to the packet number resetting to an initial value.

Aspect 88: The method of any of aspects 70 through 87, wherein the second wireless device is a multi-link device (MLD) that operates on multiple links, and wherein separate timing synchronization functions are maintained at each link.

Aspect 89: The method of any of aspects 70 through 88, wherein the first wireless communication device is a multi-link device (MLD) that operates on multiple links, and wherein a same timing synchronization function is used to generate timing synchronization function values for each link.

Aspect 90: A method for wireless communications at a first wireless communication device, comprising: generating a message integrity check (MIC) field for a frame to be transmitted to a second wireless communication device; performing an exclusive-OR (XOR) function on the MIC field to generate an XORed MIC field in which bits of the MIC field are XORed with a set of bits that correspond to a portion of a timing synchronization function value associated with the frame; and transmitting the frame, including the XORed MIC field, to the second wireless communication device.

Aspect 91: The method of aspect 90, wherein the MIC field is generated during encryption of the frame.

Aspect 92: The method of any of aspects 90 through 91, wherein the portion of the timing synchronization function value is a truncated version of the timing synchronization function value at the first wireless communication device.

Aspect 93: The method of aspect 92, wherein the truncated version of the timing synchronization function value is truncated through removal of a quantity of least significant bits of the timing synchronization function value.

Aspect 94: The method of any of aspects 92 through 93, wherein the truncated version of the timing synchronization function value is truncated by an amount that is based at least in part on potential clock drift between the first wireless communication device and at least the second wireless communication device.

Aspect 95: The method of any of aspects 92 through 94, wherein the truncated version of the timing synchronization function value is truncated through removal of a quantity of least significant bits of the timing synchronization function value.

Aspect 96: The method of any of aspects 90 through 95, further comprising: retransmitting data included in the frame in a subsequent frame, wherein the subsequent frame includes an updated XORed MIC field based on a corresponding subsequent timing synchronization function value associated with the subsequent frame.

Aspect 97: The method of aspect 96, wherein contents of the subsequent frame are not re-encrypted when the frame is retransmitted.

Aspect 98: The method of any of aspects 90 through 97, wherein the frame is a data frame or a management frame.

Aspect 99: A method for wireless communications at a second wireless communication device, comprising: receiving a frame that includes a message integrity check (MIC) field; performing an exclusive-OR (XOR) function on the MIC field to generate an XORed MIC field in which bits of the MIC field are XORed with a set of bits that correspond to a portion of a timing synchronization function value associated with a receipt time of the frame; and processing the XORed MIC field to determine frame integrity of the frame.

Aspect 100: The method of aspect 99, wherein the portion of the timing synchronization function value is a truncated version of the timing synchronization function value at the second wireless communication device.

Aspect 101: The method of aspect 100, wherein the truncated version of the timing synchronization function value is truncated by an amount that is based at least in part on potential clock drift between the second wireless communication device and a first wireless communication device.

Aspect 102: The method of any of aspects 99 through 101, further comprising: decrypting the frame; generating a received frame MIC field based on the decrypted frame; and discarding the frame responsive to a mismatch between the received frame MIC field and the XORed MIC field, or decoding the frame responsive to a match between the received frame MIC field and the XORed MIC field.

Aspect 103: The method of any of aspects 99 through 102, wherein the second wireless communication device is a multi-link device (MLD) that operates on multiple links, and wherein separate timing synchronization functions are maintained at each link.

Aspect 104: The method of any of aspects 99 through 103, wherein the first wireless communication device is a multi-link device (MLD) that operates on multiple links, and wherein a same timing synchronization function is used to generate timing synchronization function values for each link.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
generate a packet number for a frame to be transmitted to a second wireless communication device, the packet number including a first subset of bits that corresponds to a portion of a timing synchronization function value associated with the frame and a second subset of bits that corresponds to a counter value; and
transmit the frame to the second wireless communication device, the frame including a portion that includes the packet number.

2. The first wireless communication device of claim 1, wherein the frame includes a header portion and the packet number is used to protect contents of the header portion.

3. The first wireless communication device of claim 1, wherein the frame is a control frame and the packet number is used to protect contents of the control frame.

4. The first wireless communication device of claim 1, wherein, to the generate the packet number, the processing system is configured to cause the first wireless communication device to:
generate the portion of the timing synchronization function value as a truncated version of the timing synchronization function value; and
append the counter value to the portion of timing synchronization function value.

5. The first wireless communication device of claim 4, wherein the truncated version of the timing synchronization function value is truncated through removal of a quantity of least significant bits of the timing synchronization function value.

6. The first wireless communication device of claim 4, wherein the processing system is further configured to cause the first wireless communication device to:
communicate with the second wireless communication device to negotiate a number of bits to be truncated from the timing synchronization function value.

7. The first wireless communication device of claim 6, wherein the number of bits to be truncated are different for different traffic flows, the number of bits to be truncated are based at least in part on a listen interval of the first wireless communication device or the second wireless communication device, or any combinations thereof.

8. The first wireless communication device of claim 4, wherein the truncated version of the timing synchronization function value is truncated by an amount that is based at least in part on potential clock drift between the first wireless communication device and the second wireless communication device.

9. The first wireless communication device of claim 1, wherein:
the first wireless communication device is a non multi-link device (MLD) non-access point (AP) station (STA) or a non-AP STA that is affiliated with a non-AP MLD and the second wireless communication device is a non-MLD AP or an AP that is affiliated with an AP MLD, or the first wireless communication device is a non-MLD AP or an AP that is affiliated with an AP MLD and the second wireless communication device is a non-AP MLD non-AP STA or a non-AP STA that is affiliated with a non-AP MLD, and
the non-AP STA synchronizes its timing synchronization function with a corresponding timing synchronization function at the associated AP, that is operating on that link, upon a transition of the non-AP STA to an awake state.

10. The first wireless communication device of claim 1, wherein the portion of the timing synchronization function value corresponds to a time window of acceptable timing synchronization function values that is a specified time window or has a duration that is negotiated with the second wireless communication device.

11. The first wireless communication device of claim 1, wherein the frame is a first frame that has a first portion of the timing synchronization function value and a first counter value, and a second frame that is transmitted subsequent to the first frame has the first portion of the timing synchronization function value and a second counter value that is an incremented value from the first counter value.

12. The first wireless communication device of claim 11, wherein a subsequent counter value for a subsequent frame to the second frame is reset to zero responsive to a change of the portion of the timing synchronization function value.

13. The first wireless communication device of claim 1, wherein the processing system is further configured to cause the first wireless communication device to:
communicate with the second wireless communication device to negotiate a tolerance between the timing synchronization function value and a corresponding timing synchronization function value at the second wireless communication device that allows for processing of the frame at the second wireless communication device.

14. The first wireless communication device of claim 1, wherein the processing system is further configured to cause the first wireless communication device to:
rekey an encryption key associated with communications between the first wireless communication device and the second wireless communication device responsive to the packet number resetting to an initial value.

15. The first wireless communication device of claim 1, wherein the first wireless communication device is a multi-link device (MLD) that operates on multiple links, and wherein separate timing synchronization functions are maintained at each link.

16. The first wireless communication device of claim 1, wherein the first wireless communication device is a multi-link device (MLD) that operates on multiple links, and wherein a same timing synchronization function is used to generate timing synchronization function values for each link.

17. A second wireless communication device, comprising:
a processing system that includes processor circuitry and memory circuitry that stores code, the processing system configured to cause the second wireless communication device to:
receive a frame that includes a packet number including a first subset of bits that correspond to a first timing synchronization function value associated with the frame and a second subset of bits that correspond to a counter value; and
process the frame based at least on part on whether a time value indicated by the first subset of bits corresponds to a local time maintained at the second wireless communication device.

18. The second wireless communication device of claim 17, wherein the processing system is further configured to cause the second wireless communication device to:
generate a second timing synchronization function value as a truncated version of a time value of a timing synchronization function at the second wireless communication device, wherein the local time maintained at the second wireless communication device corresponds to the second timing synchronization function value, and wherein the frame is processed based at least in part on the second timing synchronization function value matching the first timing synchronization function value.

19. The second wireless communication device of claim 17, wherein the processing system is further configured to cause the second wireless communication device to:
compare the first subset of bits to a third subset of bits that correspond to a second timing synchronization function value generated at the second wireless communication device and associated with a time at which the frame is received.

20. The second wireless communication device of claim 19, wherein the processing system is further configured to cause the second wireless communication device to:
discard the frame responsive to a mismatch between the first subset of bits and the third subset of bits.

21. The second wireless communication device of claim 19, wherein the processing system is further configured to cause the second wireless communication device to:
determine, responsive to a match between the first subset of bits and the third subset of bits, that the frame is an initial frame received with the first timing synchronization function value or that the counter value exceeds a prior counter value of a prior frame with the first timing synchronization function value; and
process the frame.

22. The second wireless communication device of claim 19, wherein the processing system is further configured to cause the second wireless communication device to:
discard the frame responsive to the frame the counter value being equal to or less than a previously received counter value with the first timing synchronization function value.

23. A first wireless communication device, comprising:
a processing system that includes processor circuitry and memory circuitry that stores code, the processing system configured to cause the first wireless communication device to:
generate a message integrity check (MIC) field for a frame to be transmitted to a second wireless communication device;
perform an exclusive-OR (XOR) function on the MIC field to generate an XORed MIC field in which bits of the MIC field are XORed with a set of bits that correspond to a portion of a timing synchronization function value associated with the frame; and
transmit the frame, including the XORed MIC field, to the second wireless communication device.

24. The first wireless communication device of claim 23, wherein the MIC field is generated during encryption of the frame.

25. The first wireless communication device of claim 23, wherein the portion of the timing synchronization function value is a truncated version of the timing synchronization function value at the first wireless communication device.

26. The first wireless communication device of claim 23, wherein the processing system is further configured to cause the first wireless communication device to:
retransmit data included in the frame in a subsequent frame, wherein the subsequent frame includes an updated XORed MIC field based on a corresponding subsequent timing synchronization function value associated with the subsequent frame.

27. The first wireless communication device of claim 26, wherein contents of the subsequent frame are not re-encrypted when the frame is retransmitted.

28. The first wireless communication device of claim 23, wherein the frame is a data frame or a management frame.

29. A second wireless communication device, comprising:
a processing system that includes processor circuitry and memory circuitry that stores code, the processing system configured to cause the second wireless communication device to:
receive a frame that includes a message integrity check (MIC) field;
perform an exclusive-OR (XOR) function on the MIC field to generate an XORed MIC field in which bits of the MIC field are XORed with a set of bits that correspond to a portion of a timing synchronization function value associated with a receipt time of the frame; and
process the XORed MIC field to determine frame integrity of the frame.

30. The second wireless communication device of claim 29, wherein the processing system is further configured to cause the second wireless communication device to:
decrypt the frame;
generate a received frame MIC field based on the decrypted frame; and
discard the frame responsive to a mismatch between the received frame MIC field and the XORed MIC field, or decoding the frame responsive to a match between the received frame MIC field and the XORed MIC field.
